(19) United States
(12) Patent Application Publication
(10) Pub. No.: US 2012/0112972 A1
(43) Pub. Date: May 10, 2012

(54) ANTENNA DEVICE

(75) Inventor: Kenji Ogawa, Kanagawa (JP)

(73) Assignee: PANASONIC CORPORATION, Osaka (JP)

(21) Appl. No.: 13/383,386

(22) PCT Filed: Jul. 15, 2010
(86) PCT No.: PCT/JP2010/004614

§ 371 Date: Jan. 10, 2012

(30) Foreign Application Priority Data
Jul. 16, 2009 (JP) 2009-168139
Jul. 7, 2010 (JP) 2010-154865

(51) Int. Cl. H01Q 1/24

(52) U.S. Cl. 343/702

(57) ABSTRACT

Disclosed is an antenna device that improves the antenna gain and reduces the correlation for a MIMO antenna. Said antenna device is provided with a first housing (101) and a second housing (102). In a folding handheld terminal wherein the first housing (101) and the second housing (102) are rotatably connected by a hinge (202), the first housing (101) is provided with a first power-supply unit (107) and the second housing (102) is provided with a second power-supply unit (108). An antenna element (201) is provided inside the first housing (101) near the hinge (202). One end of the antenna element is open, and the first power-supply unit (107) and second power-supply unit (108) supply power through the other end of the antenna.

### TECHNICAL FIELD

The present invention relates to an antenna apparatus.

### BACKGROUND ART

In recent years, as various applications become increasingly sophisticated, mobile radio terminals are required to enhance their functionality. Furthermore, 3G-LTE systems or the like need a MIMO (Multiple input Multiple Output) antenna and are required to suppress correlation characteristics of radiation directivity in each antenna of the MIMO antenna to a low level.

Patent Literature 1 describes an antenna apparatus shown in FIG. 1. This antenna apparatus includes an antenna element and at least two waveguide assemblies (grounds), which are connected to connection points of the antenna element via a plurality of supply devices and insulated from each other regarding electromagnetic oscillation. Each waveguide assembly is made up of a conductor part connected to the supply device and the waveguide assembly is designed to absorb or radiate electromagnetic oscillation via the supply device. Furthermore, the conductor part is designed to absorb or radiate electromagnetic oscillation in a way similar to the way the antenna element operates.

### CITATION LIST

### Patent Literature

PTL1
Japanese Patent Application Laid-Open No. HEI 10-79617

### SUMMARY OF INVENTION

### Technical Problem

However, it is structurally impossible for the antenna apparatus disclosed in Patent Literature 1 above to mount the two waveguide assemblies on a mobile radio terminal such as mobile phone. Furthermore, arranging the two waveguide assemblies in the same case generates interference between the waveguide assemblies, deteriorates the antenna gain and makes it difficult to achieve low correlation.

The present invention has been implemented in view of such problems and it is an object of the present invention to provide an antenna apparatus that improves the antenna gain and achieves low correlation in a MIMO antenna.

### Solution to Problem

An antenna apparatus of the present invention is an antenna apparatus mounted on a flip mobile terminal provided with a first case and a second case, and a hinge section that rotatably connects the first case and the second case, and adopts a configuration including a first ground plate incorporated in the first case, a second ground plate incorporated in the second case, an antenna element provided in the vicinity of the hinge section, resonating at a desired frequency and having one open end, a first power supply section connected to the first ground plate to supply power from the other end of the antenna element and a second power supply section connected to the second ground plate to supply power from the other end of the antenna element.

### Advantageous Effects of Invention

The present invention can improve the antenna gain and achieve low correlation in a MIMO antenna.

### BRIEF DESCRIPTION OF DRAWINGS

FIG. 1 illustrates an antenna apparatus described in Patent Literature 1;

FIG. 2 illustrates a configuration of a mobile terminal according to Embodiment 1 of the present invention;

FIG. 3 illustrates a situation in which a three-dimensional coordinate system is provided;

FIG. 4 illustrates a frequency characteristic of VSWR;

FIG. 5 illustrates radiation directivity (horizontal polarized wave component) of an XZ plane;

FIG. 6 illustrates a horizontal polarized wave phase characteristic;

FIG. 7 illustrates a configuration of a mobile terminal according to Embodiment 2 of the present invention;

FIG. 8 illustrates another configuration of the mobile terminal according to Embodiment 2 of the present invention;

FIG. 9 illustrates a configuration of a mobile terminal according to Embodiment 3 of the present invention;

FIG. 10 illustrates antenna current paths in the configuration (structure 1) shown in FIG. 2;

FIG. 11 illustrates antenna current paths in the configuration (structure 1) shown in FIG. 9;

FIG. 12 illustrates measurement results of S-parameters of structure 1 and structure 2;

FIG. 13 illustrates another configuration of the mobile terminal according to Embodiment 3 of the present invention;

FIG. 14 illustrates antenna current paths in the configuration (structure 3) shown in FIG. 13;

FIG. 15 illustrates measurement results of S-parameters in structures 1 to 3;

FIG. 16 illustrates a configuration of a mobile terminal without using any coaxial cable; and

FIG. 17 illustrates a configuration of a mobile terminal having a first ground plate and a second ground plate of different sizes.

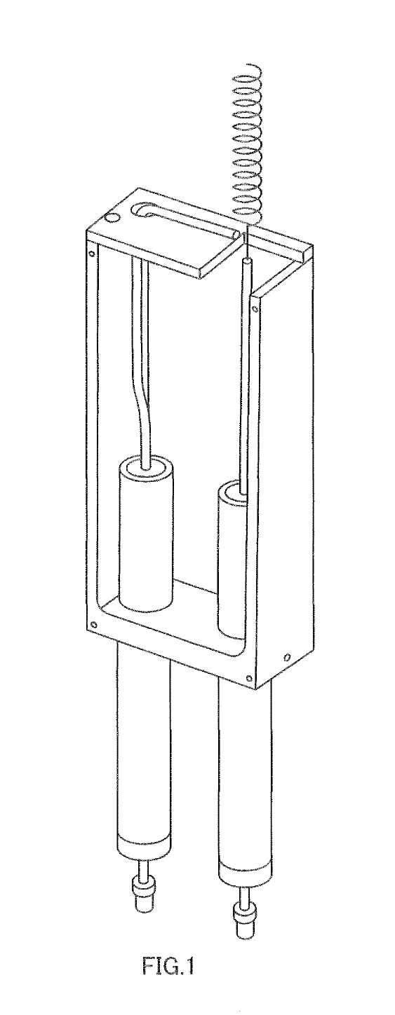

### DESCRIPTION OF EMBODIMENTS

Hereinafter, embodiments of the present invention will be described in detail with reference to the accompanying drawings. However, components having the same functions among the embodiments will be assigned the same reference numerals and overlapping descriptions will be omitted.

### Embodiment 1

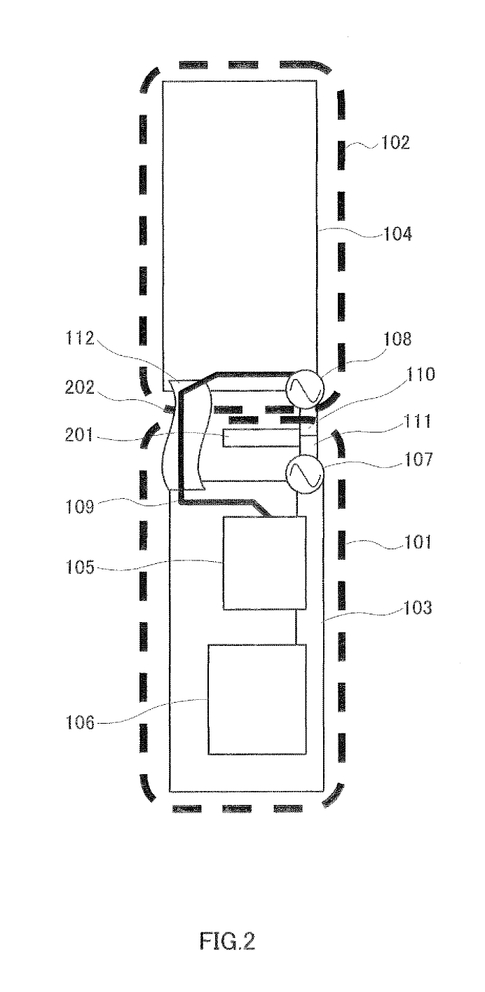

FIG. 2 illustrates a configuration of a mobile terminal according to Embodiment 1 of the present invention. The mobile terminal shown in this figure has a folding shape, and first case 101 and second case 102 are rotatably connected together by hinge section 202.

First case 101 incorporates first ground plate 103, second case 102 incorporates second ground plate 104, and first ground plate 103 and second ground plate 104 are connected together via data communication line 112.

First ground plate 103 is provided with radio circuit 105 and signal processing section 106 connected to this radio circuit 105. Furthermore, first ground plate 103 includes first power supply section 107 connected to radio circuit section 105 and having transmitting and receiving functions.

Second ground plate 104 includes second power supply section 108 connected to radio circuit 105 via coaxial cable 109 and having transmitting and receiving functions.

One end of first strip element 110 is connected to first power supply section 107 and the other end of first strip element 110 is connected to antenna element 201 provided near hinge section 202 inside first case 101. Furthermore, one end of second strip element 111 is connected to second power supply section 108 and the other end of second strip element 111 is connected to antenna element 201.

One end of antenna element 201 is connected to first strip element 110 and second strip element 111 and the other end is left open.

As specific sizes, suppose, for example, first ground plate 103 and second ground plate 104 have a width of 45 mm, a length of 100 mm, antenna element 201 has a length of 25 mm and the strip element between power supply points has a length of 30 mm.

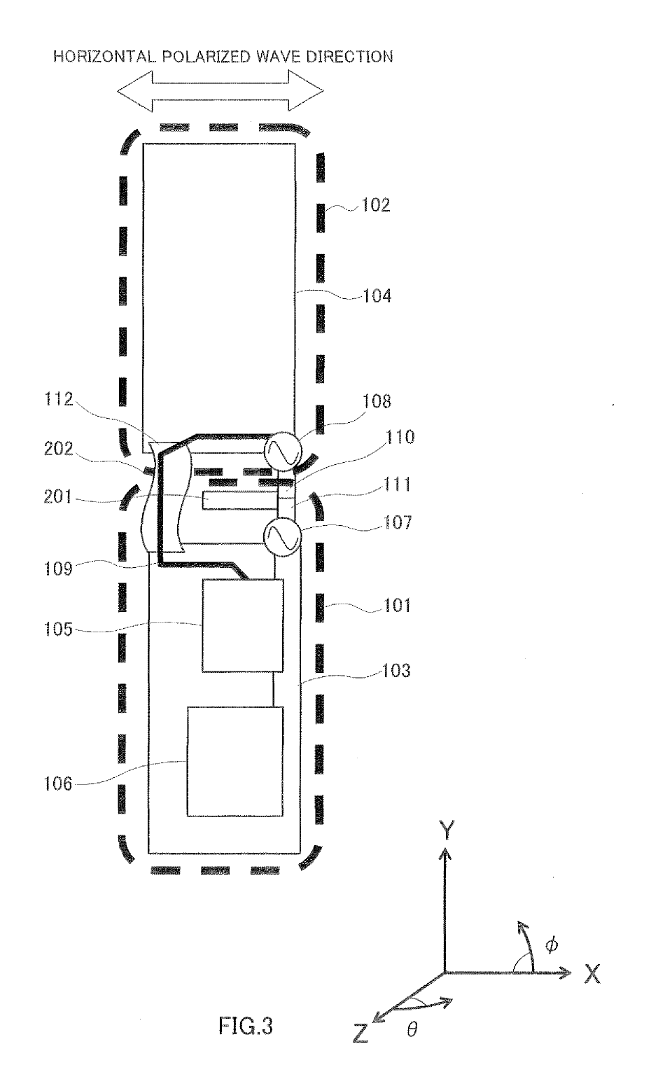

FIGS. 3 to 5 show results of an electromagnetic field simulation of the antenna having such a size. FIG. 3 illustrates a situation in which a three-dimensional coordinate system is provided. As shown in FIG. 3, suppose the horizontal direction of the mobile terminal is the X-axis, the length direction is the Y-axis and the width direction is the Z-axis. Furthermore, the angle formed with respect to the XZ plane is φ and the angle formed with respect to the YZ plane is θ.

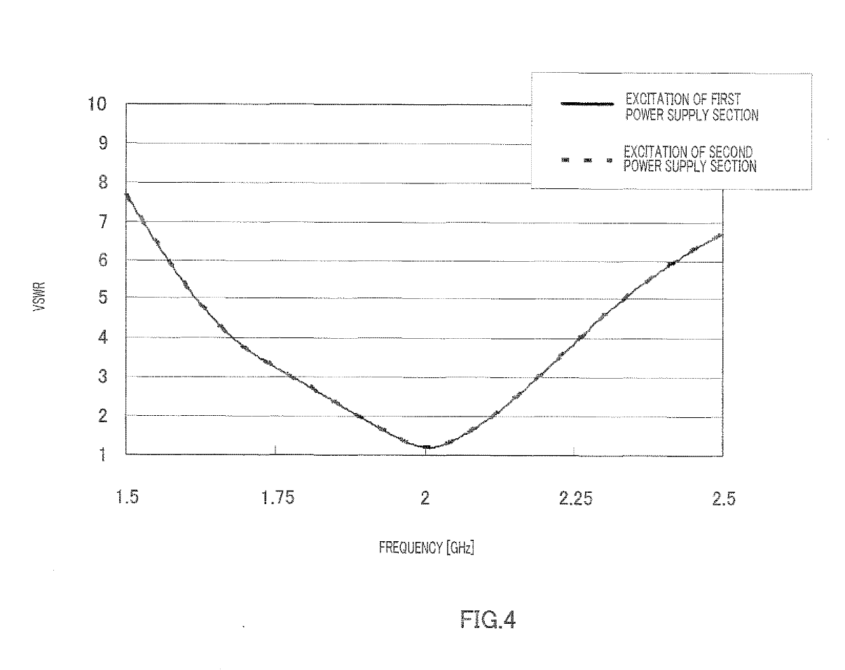

FIG. 4 illustrates a frequency characteristic of VSWR. In FIG. 4, a thick solid line represents a frequency characteristic of VSWR when first power supply section 107 is excited and a broken line represents a frequency characteristic of VSWR when second power supply section 108 is excited. As is clear from this figure, the thick solid line and the broken line overlap each other and resonance centered on the same 2 GHz is obtained even when both power supply sections are excited.

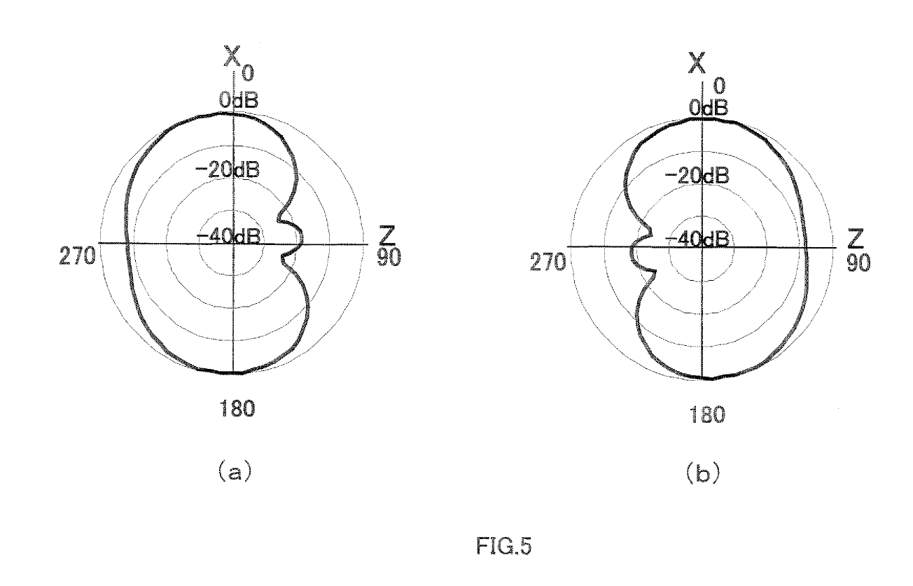

FIG. 5 illustrates a horizontal polarized wave component of radiation directivity of the mobile terminal of the XZ plane in FIG. 3. FIG. 5(a) illustrates radiation directivity when first power supply section 107 is excited and FIG. 5(b) illustrates radiation directivity when second power supply section 108 is excited. As is clear from these figures, the radiation directivity is symmetric, which allows the correlation characteristic of the radiation directivity to be suppressed low.

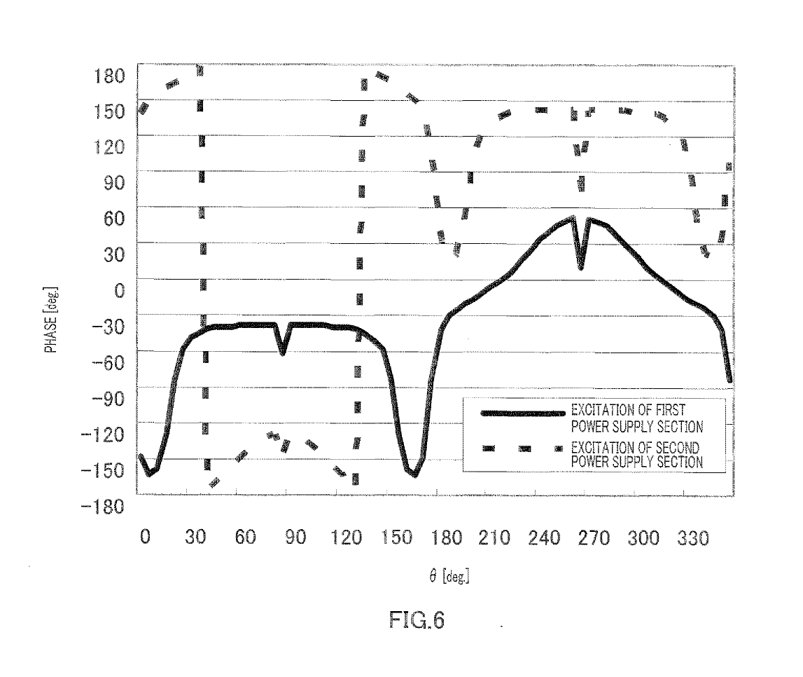

Furthermore, FIG. 6 illustrates a phase characteristic. FIG. 6 illustrates the phase of the XZ plane in FIG. 3. In FIG. 6, a thick solid line represents the phase of a horizontal polarized wave when first power supply section 107 is excited and a broken line represents the phase of a horizontal polarized wave when second power supply section 108 is excited. As is clear from this figure, the phase characteristic also has a characteristic symmetric between the power supply sections bordered at θ=180° and the correlation characteristic of the phase characteristic can also be suppressed low. A possible reason for this may be that an unbalanced operation of the antenna causes a current flowing into the ground plate on which each power supply section is arranged to become dominant.

Furthermore, in the aforementioned size, a correlation coefficient (CC) obtained using a Pearson product-moment correlation expressed in equation 1 shown below was as low as 0.3 in its horizontal polarized wave component.

That is, it is possible to realize low correlation of antenna directivity radiating from the respective power supply sections.

[1]

$$CC = {[ \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} ]}^{2} \qquad ( Equation 1 )$$

where, antenna complex directivity from each power supply section is represented by x={xᵢ}, y={yᵢ}, (i=1, 2, . . . , n) and x⁻ represents an average value of x={xᵢ} and y⁻ represents an average value of y={yᵢ}.

Thus, Embodiment 1 provides a first power supply section in a first case and a second power supply section in a second case of a flip mobile terminal, arranges an antenna element in the vicinity of a hinge section that rotatably connects the first case and the second case, connects the first power supply section and the second power supply section to one end of the antenna element respectively, and can thereby realize a plurality of antenna effects in one antenna element, and further improve the antenna gain and realize low correlation of antenna directivity.

### Embodiment 2

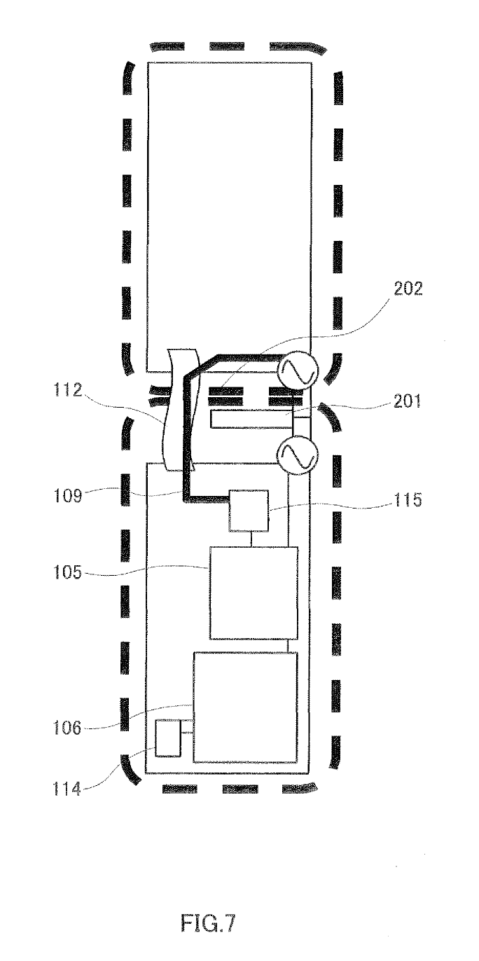

FIG. 7 illustrates a configuration of a mobile terminal according to Embodiment 2 of the present invention. FIG. 7 is different from FIG. 2 in that case state sensor 114 and switching circuit 115 are added.

Case state sensor 114 detects whether a flip mobile terminal is in a closed state or in an open state and reports the detection result to switching circuit 115 via signal processing section 106 and radio circuit 105.

Switching circuit 115 switches whether or not to connect radio circuit 105 and second power supply section 108, that is, turns ON/OFF of the second power supply section according to the detection result outputted from case state sensor 114. To be more specific, switching circuit 115 connects radio circuit 105 and second power supply section 108 when the detection result outputted from case state sensor 114 indicates an open state of the mobile terminal, and disconnects radio circuit 105 from second power supply section 108 when the detection result indicates a closed state of the mobile terminal.

When the mobile terminal is in a closed state and continues to receive power supply from first power supply section 107 and second power supply section 108, the antenna gain deteriorates due to a positional relationship between first ground plate 103 and second ground plate 104, but by disconnecting radio circuit 105 from second power supply section 108 and stopping power supply from second power supply section 108, it is possible to prevent the antenna gain from deteriorating.

Thus, according to Embodiment 2, when the mobile terminal is in a closed state, the switching circuit disconnects the radio circuit from the second power supply section and stops power supply from the second power supply section, and can thereby prevent the antenna gain from deteriorating.

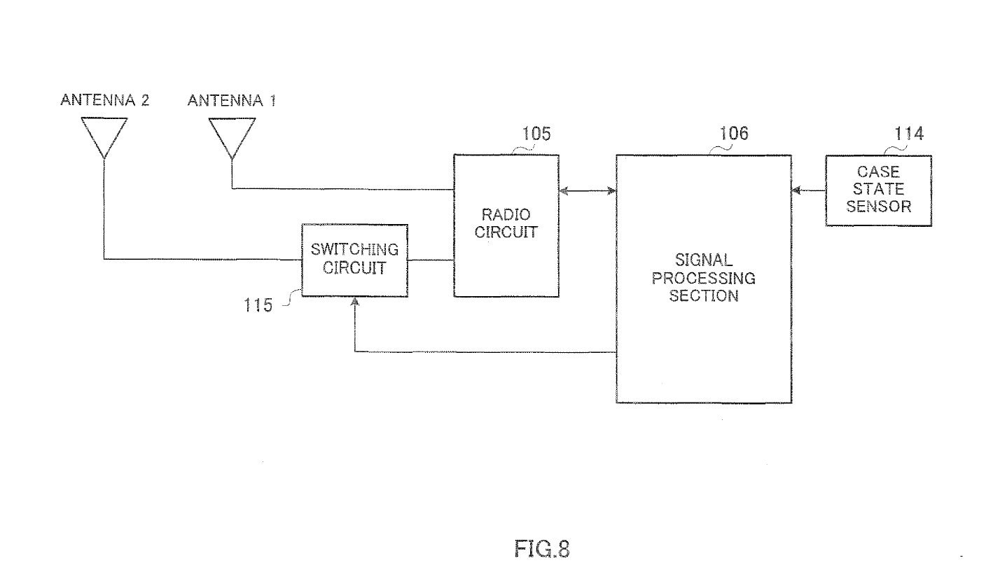

Although a case has been described in the present embodiment where switching circuit 115 is controlled based on the result of case state sensor 114 detecting an open/closed state of the mobile terminal, as shown in FIG. 8, signal processing section 106 may be provided with a receiving power detection circuit in addition to case state sensor 114 so that switching circuit 115 disconnects radio circuit 105 from second power supply section 108 when receiving power detected by the receiving power detection circuit falls to or below a predetermined value.

### Embodiment 3

FIG. 9 illustrates a configuration of a mobile terminal according to Embodiment 3 of the present invention. FIG. 9 is different from FIG. 2 in that antenna element 201 is changed to antenna element 301. However, FIG. 9 only illustrates a portion of the mobile terminal in the vicinity of hinge section 202.

Antenna element 301 has a length of λ/4 and is arranged perpendicular to the plane of the ground plate (first ground plate 103 or second ground plate 104), and one end of the antenna element is connected to first strip element 110 and second strip element 111, and the other end is left open.

Antenna element 301 arranged in this way functions as an open stub at a desired frequency. This allows isolation performance to be secured between first power supply section 107 and second power supply section 108 at the desired frequency.

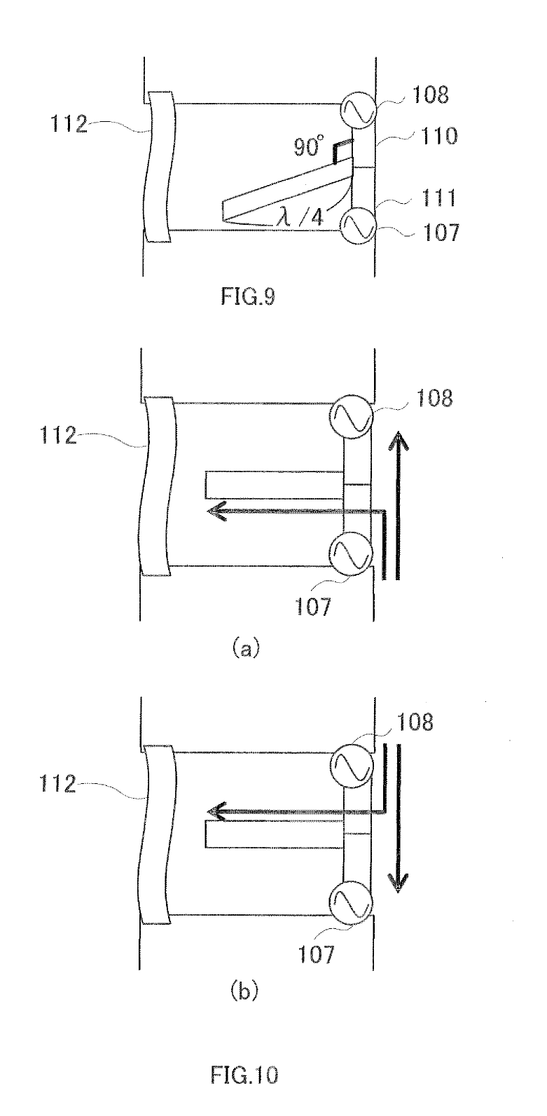

Here, FIG. 10 illustrates antenna current paths in the configuration (structure 1) shown in FIG. 2. FIG. 10(a) illustrates antenna current paths in structure 1 when first power supply section 107 is excited. In this case, antenna current leakage not only to antenna element 201 but also to first strip element 110 occurs. Furthermore, FIG. 10(b) illustrates antenna current paths in structure 1 when second power supply section 108 is excited. As shown in FIG. 10(b), antenna current leakage not only to antenna element 201 but also to second strip element 111 occurs.

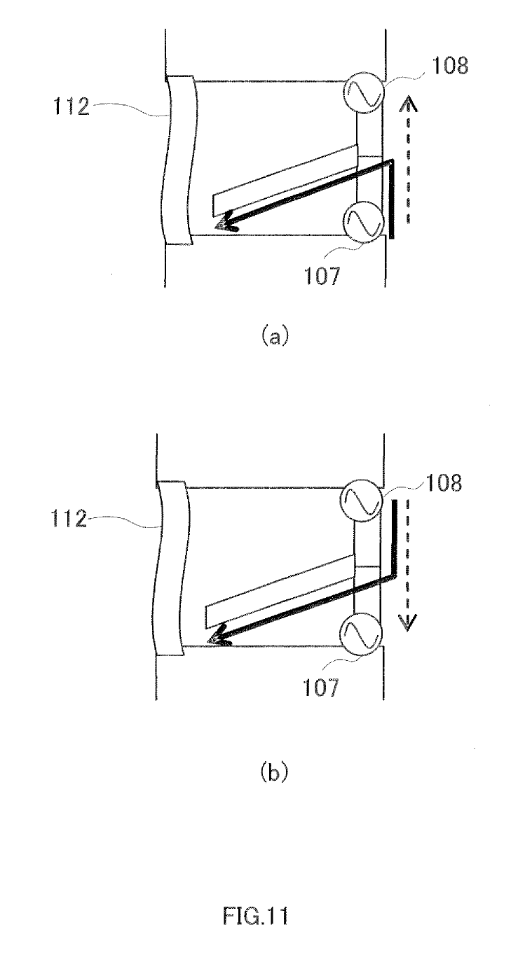

On the other hand, FIG. 11 illustrates antenna current paths in the configuration (structure 2) shown in FIG. 9. FIG. 11(a) illustrates antenna current paths in structure 2 when first power supply section 107 is excited. In this case, an antenna current flows into antenna element 301 and substantially no antenna current leaks to first strip element 110. Furthermore, FIG. 11(b) illustrates antenna current paths in structure 2 when second power supply section 108 is excited. As shown in FIG. 11(b), in this case, an antenna current flows into antenna element 301 and substantially no antenna current leaks to second strip element 111. This is because the antenna current becomes 0 at an end of antenna element 301 and no reflected current is generated.

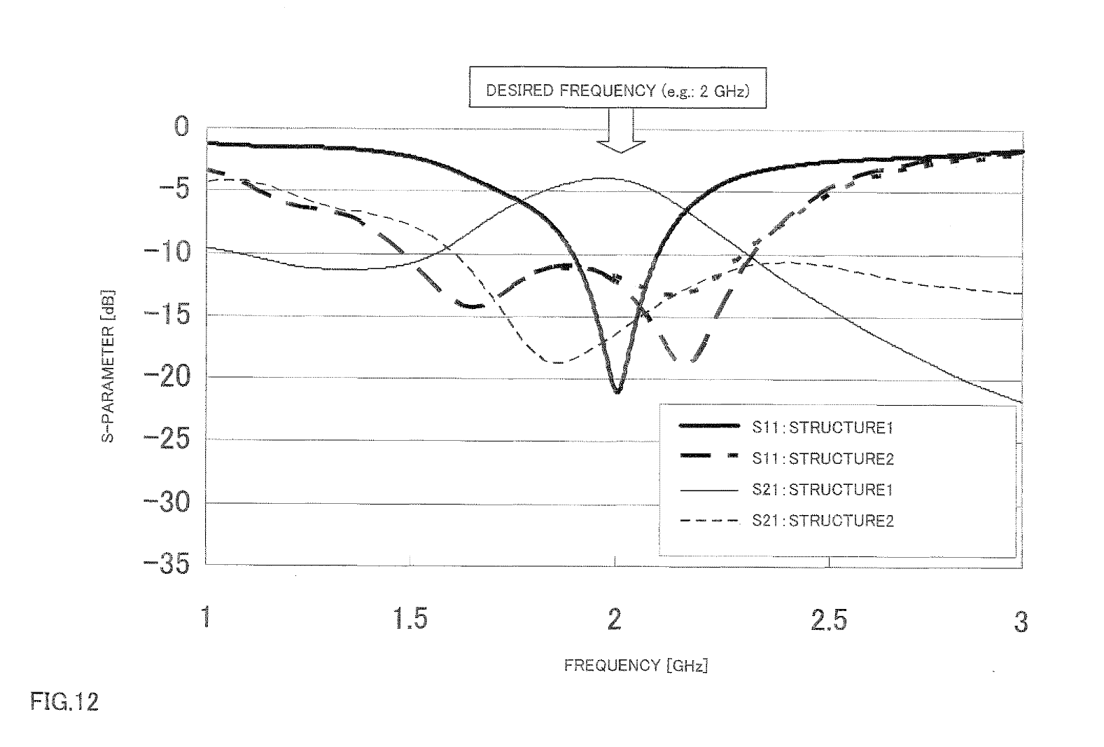

Next, FIG. 12 illustrates measurement results of S-parameters in structure 1 and structure 2 assuming a desired frequency is 2 GHz. In structure 1, resonance takes place with S11 falling below −10 dB at 2 GHz, but an isolation characteristic (S21) between the power supply sections does not fall below −10 dB at 2 GHz, and it can be confirmed that both are not mutually compatible at the desired frequency. On the other hand, in structure 2, a fractional bandwidth of the resonance frequency improves from that of structure 1 and the isolation characteristic (S21) between the power supply sections falls below −10 dB, and it can be confirmed that both are mutually compatible at the desired frequency.

Thus, since the isolation performance between first power supply section 107 and second power supply section 108 at a desired frequency can be secured, electrical interference between first power supply section 107 and second power supply section 108 is suppressed and it is thereby possible to improve the radiation gain characteristic at the time of excitation of first power supply section 107 and second power supply section 108 respectively. Furthermore, regarding also the performance of the radio circuit connected to first power supply section 107 and second power supply section 108 respectively, it is possible to suppress mutual leakage of transmission currents.

Thus, Embodiment 3 provides an antenna element having a length of λ/4, arranged perpendicular to the surface of a ground plate, one end of which is connected to a first strip element and a second strip element and the other end of which is left open, and can thereby secure isolation performance between the first power supply section and the second power supply section at a desired frequency, thereby suppress electrical interference between the first power supply section and the second power supply section and improve the radiation gain characteristic at the time of excitation of the first power supply section and the second power supply section respectively.

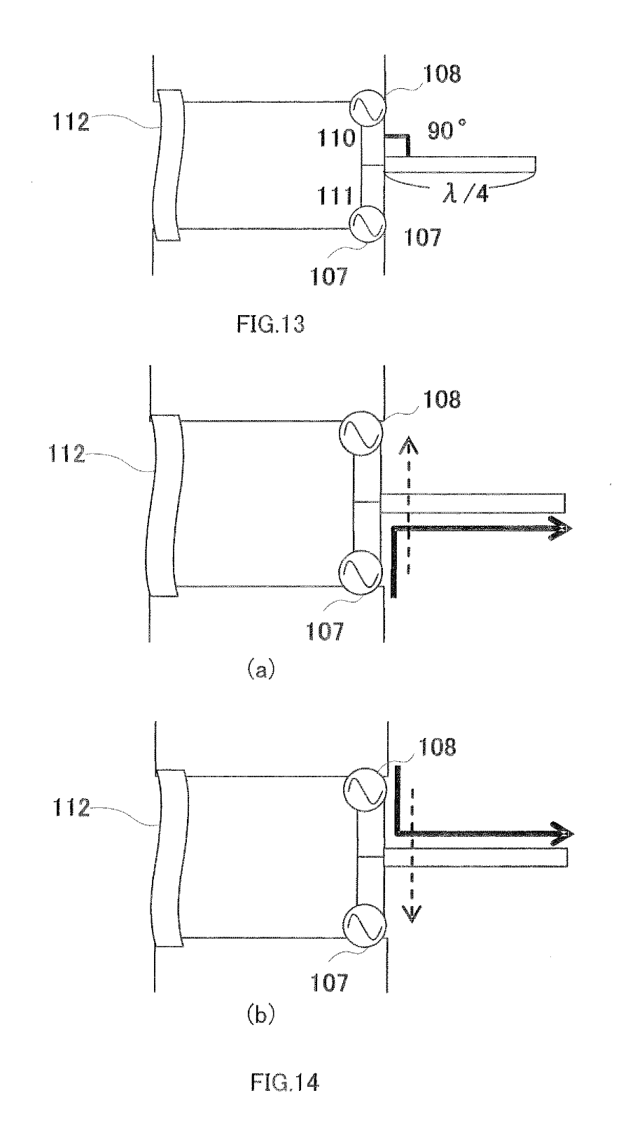

As shown in FIG. 13, it may also be possible to arrange an antenna element perpendicular to the long side of the ground plate (first ground plate 103 or second ground plate 104) so as to protrude from first case 101 (or second case 102) on the same plane as the ground plate (in the +X direction on the coordinate axis shown in FIG. 3), connect one end thereof to first strip element 110 and second strip element 111 and leave open the other end.

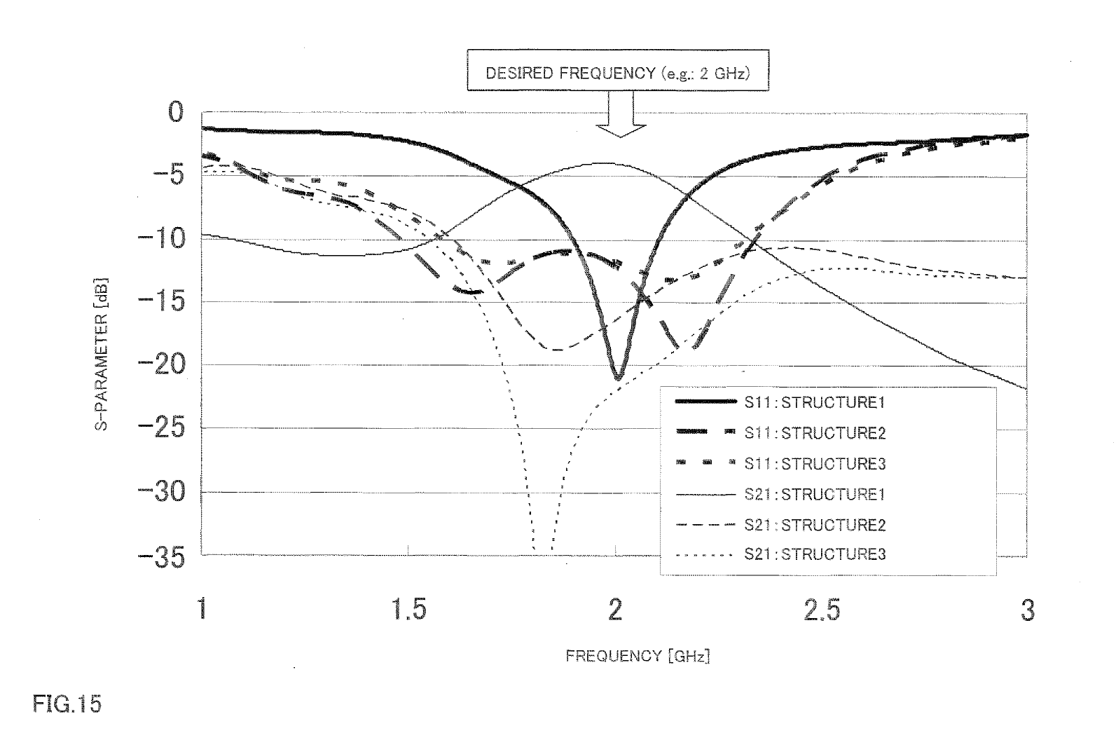

FIG. 14 illustrates an antenna current path in the configuration (structure 3) shown in FIG. 13. FIG. 14(a) illustrates an antenna current path in structure 3 when first power supply section 107 is excited. In this case, an antenna current flows into the antenna element and no antenna current flows into first strip element 110. Furthermore, FIG. 14(b) illustrates an antenna current path in structure 3 when second power supply section 108 is excited. As shown in FIG. 14(b), in this case, an antenna current flows into the antenna element and no antenna current flows into second strip element 111.

Thus, in the arrangement shown in FIG. 13, the antenna element also functions as an open stub at a desired frequency. Thus, isolation performance between first power supply section 107 and second power supply section 108 can be secured at the desired frequency.

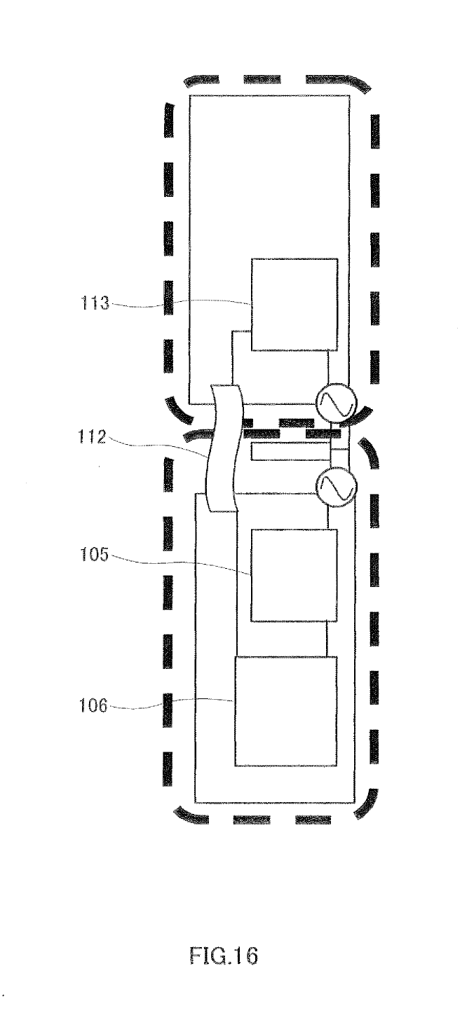

FIG. 15 illustrates measurement results of S-parameters in structure 3. As is clear from the figure, a fractional bandwidth of the resonance frequency in structure 3 also improves from that in structure 1 and the isolation characteristic (S21) between the power supply sections falls below −10 dB, and it can be confirmed that both are mutually compatible at the desired frequency.

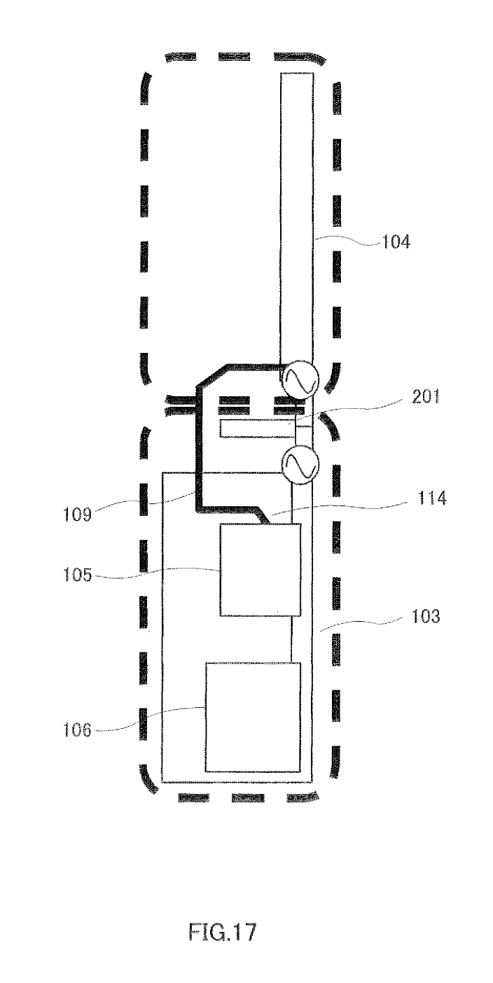

A case has been described in the above-described embodiments where radio circuit 105 inside the first case and the second power supply section are connected together via a coaxial cable, but as shown, for example, in FIG. 16, it may also be possible to provide radio circuit 113 connected to signal processing section 106 via data communication line 112 in the second ground plate so as to connect radio circuit 113 to the second power supply section.

It has been assumed in the above-described embodiments that first ground plate 103 and second ground plate 104 have the same size, but the present invention is not limited to this, and first ground plate 103 may be greater or smaller than second ground plate 104. FIG. 17 illustrates a case where first ground plate 103 is greater than second ground plate 104.

When part of the first case or second case or the whole of the first case or second case is metallic, it may be possible to connect the metallic case to the first ground plate or second ground plate and thereby change the size of the ground.

A case has been described in the above-described embodiments where antenna element 201 is provided in first case 101, but antenna element 201 may also be provided in second case 102 as long as it is located in the vicinity of hinge section 202.

Antenna element 201 or antenna element 301 described above is also applicable to a metallic part (e.g., hinge metal of a flip terminal) having substantially the same length as the assumed antenna element when mounted on a mobile terminal.

The disclosures of Japanese Patent Application No. 2009-168139, filed on Jul. 16, 2009 and Japanese Patent Application No. 2010-154865, filed on Jul. 7, 2010, including the specification, drawings and abstract are incorporated herein by reference in its entirety.

### INDUSTRIAL APPLICABILITY

The antenna apparatus according to the present invention is applicable to a radio communication terminal apparatus such as a flip mobile phone.

### REFERENCE SIGNS LIST

101 First case
102 Second case
103 First ground plate
104 Second ground plate
105, 113 Radio circuit
106 Signal processing section
107 First power supply section
108 Second power supply section
109 Coaxial cable
110 First strip element
111 Second strip element
112 Data communication line
114 Case state sensor
115 Switching circuit
201, 301 Antenna element
202 Hinge section

1. An antenna apparatus mounted on a flip mobile terminal provided with a first case and a second case, and a hinge section that rotatably connects the first case and the second case, comprising:
a first ground plate incorporated in the first case;
a second ground plate incorporated in the second case;
an antenna element provided in the vicinity of the hinge section, resonating at a desired frequency and having one open end;
a first power supply section connected to the first ground plate to supply power from the other end of the antenna element; and
a second power supply section connected to the second ground plate to supply power from the other end of the antenna element.

2. The antenna apparatus according to claim further comprising:
a case state detection section that detects whether the flip mobile terminal is an open state or closed state; and
a switching section that controls ON/OFF of the second power supply section according to the detection result of the case state detection section.

3. The antenna apparatus according to claim 2, further comprising a receiving power detection section that detects receiving power of a received signal, wherein
the switching section controls ON/OFF of the second power supply section according to the receiving power.

4. The antenna apparatus according to claim wherein the antenna element has a ¼ wavelength, is arranged perpendicular to the plane of the first ground plate or the second ground plate, one end of the antenna element left open.

5. The antenna apparatus according to claim 1, wherein the antenna element has a ¼ wavelength, is arranged perpendicular to the long side of the first ground plate or the second ground plate so as to protrude from the first case or the second case on the same plane as the ground plate, one end of the antenna element left open.
